(19) United States
(12) Patent Application Publication
(10) Pub. No.: US 2014/0206363 A1
(43) Pub. Date: Jul. 24, 2014

(54) METHOD FOR ROUTING TELECOMMUNICATIONS CONNECTIONS TO A MOBILE RADIO TERMINAL AND MOBILE RADIO GATEWAY

(71) Applicants: Frank Paetsch, Berlin (DE); Heiner Berndt, Berlin (DE)

(72) Inventors: Frank Paetsch, Berlin (DE); Heiner Berndt, Berlin (DE)

(73) Assignee: TELES AG INFORMATIONSTECHNOLOGIEN, Berlin (DE)

(21) Appl. No.: 14/112,224

(22) PCT Filed: Apr. 18, 2012
(86) PCT No.: PCT/EP12/57048

§ 371 Date: Mar. 27, 2014

(30) Foreign Application Priority Data
Apr. 20, 2011 (DE) 10 2011 007 814.2

(51) Int. Cl. H04W 40/24

(52) U.S. Cl. CPC H04W 40/248
USPC 455/445

(57) ABSTRACT

The invention relates to a method for routing telecommunications connections (TC connections) to a mobile radio terminal (1) which is not located in the receive region of its home network (7), wherein the mobile radio terminal (1) includes a SIM card (2) with SIM information data (15) assigned to the home network (7) and a first call number is assigned to the SIM card (2). The method comprises the following steps:
triggered by an event, automatic generation of a message (13) in the mobile radio terminal (1) or a device (51, 52) assigned to the same, which includes at least the SIM information data (15) of the SIM card (2) or an information which identifies the SIM card;
sending of the message (13) from the mobile radio terminal (1) or the device (51, 52) connected with the mobile radio terminal (1) directly or indirectly to a mobile radio gateway (4);
providing assignment information (14) at the mobile radio gateway (4), which identifies the sender of the message (13);
after receipt of the message (13) at the mobile radio gateway (4) inscribing a module of the mobile radio gateway (4) at the location of the mobile radio gateway (4) in the home network (7) by using the received SIM information data (15) or by using a partner SIM card, so that each TC connection addressed to the first call number is routed to the mobile radio gateway (4); and
forwarding such TC connection from the mobile radio gateway (4) to the sender (1, 51, 52) by using the assignment information (14).

The invention furthermore relates to a mobile radio gateway which is suitable for participating in carrying out such method.

### CROSS-REFERENCE TO A RELATED APPLICATION

This application is a National Phase Patent Application of International Patent Application Number PCT/EP2012/057048, filed on Apr. 18, 2012, which claims priority of German Patent Application Number 10 2011 007 814.2, filed on Apr. 20, 2011.

### BACKGROUND

This invention relates to a method for routing telecommunications connections (TC connections) to a mobile radio terminal. It furthermore relates to a mobile radio gateway which is suitable for participating in carrying out the method.

It is known that in the case of the stay of the user of the mobile radio terminal in a foreign country a mobile radio terminal maintains its connectivity via an international roaming and correspondingly is able to automatically receive or make calls in a foreign mobile radio network of the other country. At the same time, the situation is such that mobile radio providers charge high routing fees for an international roaming, so that the use of roaming abroad involves considerable costs. The same problems arise—although in general with smaller cost consequences—with each utilization of a mobile radio network which is not the home network of a mobile radio terminal under consideration.

Furthermore, so-called mobile radio gateways are known, which provide an interface between one or more mobile radio telecommunications networks and any other networks, for example a fixed telecommunications network or an IP network. A mobile radio gateway is called by the user of another network and forwards the desired connection via a mobile radio channel into the mobile radio network in which the called subscriber is located. For this purpose, the mobile radio gateway implements the functionality of a mobile radio telephone and calls the called subscriber as a mobile radio telephone, so to speak. Mobile radio gateways thus are provided with the same mobile radio modules as they are used in mobile radio terminals (mobile phones). Such mobile radio gateways are known for example from DE 103 14 144 A1.

It is provided that a mobile radio gateway contains a plurality of SIM cards for the mobile radio channels managed. Any kind of SIM cards of various network operators can be used. A SIM card is a plug-in card with an identifier (IMSI=International Mobile Subscriber Identity) which unambiguously identifies a network subscriber and via which a mobile radio device is assigned to a particular network operator and receives a particular call number. As further SIM information data a SIM card also has a PIN number (PIN—Personal Identity Number), safety-relevant data such as communication keys and safety algorithms, user-specific data such as speed-dial numbers and network-specific data such as the identifier of the current location area. A SIM card personalizes a mobile radio terminal with regard to the user and with regard to the network operator and provides for the accounting of call charges of the network operator.

Furthermore, so-called SIM servers are known. In a SIM server, SIM cards for the mobile radio communication are provided at a central location or a central computer. Depending on the individual specifications and needs, a SIM card is requested on the part of a mobile radio gateway from the central computer and provided by the same to the mobile radio gateway. Such providing of the SIM card for the mobile radio communication is not effected physically. Merely the SIM information data which identify a SIM card and reflect its functionality are transmitted to the mobile radio gateway via remote data transmission. Thus, the SIM card virtually is located on a central computer, so to speak, and when necessary, its functionality is emulated on the mobile radio gateway on the basis of specific information and data which are transmitted from the central computer. This provides for the use of a central SIM card pool for one or more mobile radio gateways. Such SIM servers are described for example in DE 103 11 980 A1.

It is an object underlying the present invention to provide a method for routing telecommunications connections (TC connections) to a mobile radio terminal, which reduces the costs connected with a conventional roaming and nevertheless provides a connectivity of the mobile radio terminal. It furthermore is the object underlying the present invention to provide a mobile radio gateway which can be used in such method.

The method according to the invention proceeds from the situation that a mobile radio terminal is not located in the receive region of its home network. The mobile radio terminal for example is located in a foreign country, based on the country in which its home network is located. However, there can also be the situation that the currently available mobile radio network is any other mobile radio network of the same country or that at the location of the mobile radio terminal no mobile radio network currently is accessible at all. The mobile radio terminal includes a first SIM card assigned to the home network. In a manner known per se, the SIM card comprises SIM information data which in general include an IMSI, a PIN, safety algorithms and user-specific data. To the SIM card a first call number is assigned, which likewise can be, but need not be contained on the SIM card.

In a first step according to an exemplary embodiment of the invention a message automatically is generated in the mobile radio terminal or a device associated to the same. This message at least contains the SIM information data of the SIM card, i.e. that information which is required for inscribing the SIM card in the home network. An event which triggers the generation of such message for example can be the detection that a foreign mobile radio network and/or a mobile radio network alternative to the home network and/or no or no desired mobile radio network are present at the location of the mobile radio terminal. An event which triggers the generation of such message furthermore can be a defined manual input of a user of the mobile radio terminal.

In a second step, the message is sent from the mobile radio terminal or a device connected with the mobile radio terminal directly or indirectly to a mobile radio gateway. In one design variant, such sending is effected by means of a software application of the mobile radio terminal. In another design variant it is provided that the message is sent by a device connected with the mobile radio terminal, which for example is a PC, a notebook, a netbook or an integrated access device (IAD).

In a further step, assignment information is provided at the mobile radio gateway, which identifies the sender of the message, i.e. the mobile radio terminal or the device connected with the mobile radio terminal. Via the assignment information, the mobile radio gateway is enabled to communicate with the sender of the message and to forward in particular voice data and other data, which the sender receives from a third party, to the mobile radio terminal. The assignment information for example is sender information which is provided automatically in connection with e.g. a VoIP registration or by a suitable configuration.

After receipt of the messages at the mobile radio gateway, a module of the mobile radio gateway inscribes at the location of the mobile radio gateway in the home network by using the SIM information data received. The consequence is that each TC connection addressed to the first call number subsequently is routed to the mobile radio gateway. The mobile radio gateway now assigns such TC connection to the sender of the message with reference to the assignment information. It will then route such TC connection from the mobile radio gateway to the sender.

It can likewise be provided that each TC connection which goes out from the mobile radio gateway, for example an outgoing telephone call, first is routed to the mobile radio gateway (for example via an IP network or a TDM network) and is sent from the same via the home network to the receiver by mobile radio. It can be provided that the corresponding TC connection is routed from the home network to the receiver not directly, but via one or more further networks.

Thus, a method is provided in which the SIM information data of the SIM card of a mobile radio terminal are transmitted to a mobile radio gateway via data transmission. The same (or one of its modules) then inscribes at the location of the mobile radio gateway in the mobile radio home network of the mobile radio terminal by using these SIM information data. The home network hence regards the corresponding module of the mobile radio gateway as mobile radio terminal of the SIM card.

The mobile radio terminal or the external device assigned to the same has a connectivity to the mobile radio gateway, for which purpose the same for example are connected with each other via a further communication network. There is a logical connection from the sender of the message to the mobile radio gateway. All incoming and outgoing calls are routed via the mobile radio gateway. For example, incoming calls and other TC connections are routed from the mobile radio home network via the mobile radio gateway and the further communication network to the external terminal or mobile radio terminal.

The method according to the invention allows to maintain a connectivity by using the own SIM card of a mobile radio terminal, even when no desired mobile radio network is present at the location of the mobile radio terminal or when no mobile radio network at all is present at the location of the mobile radio terminal. By means of the method according to the invention all incoming and outgoing calls can be realized in the usual way by using the own SIM card (or its information data), wherein in particular the costs of an international roaming can be avoided.

In a modification of the method according to the invention it is provided that instead of the SIM information data information which merely identifies the SIM card is sent in the message. The information which identifies the SIM card for example can be a privately agreed code or a particular identification number which is assigned to the SIM card. This information then is used to inscribe a partner SIM card of the SIM card in the mobile radio gateway. In one aspect, the partner SIM card already is present in the mobile radio gateway and will be activated at the latest when the mobile radio gateway receives the message from the mobile radio terminal with the information which identifies the SIM card. Via the sent information, which identifies the SIM card, the partner SIM card then can be assigned.

Alternatively, it can be provided that the partner SIM card is arranged in a SIM server and merely the data relevant for an authentication in the home network are transmitted to the mobile radio gateway and the SIM card is emulated there. The transmission of the data relevant for an authentication in the home network to the mobile radio gateway is effected when the message generated in the mobile radio terminal arrives at the mobile radio gateway and/or the SIM server. It can be provided that the message first arrives at the mobile radio gateway and the same then informs the SIM server about the receipt of the message, whereupon the data relevant for an authentication in the home network are sent from the SIM server to the mobile radio gateway. It can likewise be provided that the message automatically generated in the mobile radio terminal is sent to the mobile radio gateway via the SIM server and thus first is present at the SIM server, whereupon the SIM server sends the data relevant for an authentication in the home network to the mobile radio gateway.

Partner SIM cards are known per se. This is a SIM card to which the same call number is assigned as to the actual SIM card, but which has a different IMSI. The partner SIM card must already have been applied for and must already be present, before the method is carried out.

It should be noted that the term “SIM card” in the sense of the present invention designates every plug-in card which unambiguously identifies a network subscriber, so that a mobile radio device with such plug-in card can be assigned to a particular network operator and receive a particular call number. The term “SIM card” thus designates not only plug-in cards for identification of a subscriber in the GSM standard, but also plug-in cards for identification of a network subscriber of any other current or future mobile radio standards.

In one exemplary aspect of the invention the mobile radio terminal and/or the device connected with the mobile radio terminal are connected with the mobile radio gateway via at least one communication network, so that a data connection can be established between these TC units. In particular, the sending of the message from the mobile radio gateway or a device connected with the mobile radio gateway to the mobile radio gateway as well as forwarding a TC connection between the mobile radio terminal and the mobile radio gateway is effected via the at least one communication network. In one aspect, the assignment information which provides for an assignment of the sender of the message and its identification from the point of view of the mobile radio gateway, at least comprises the address of the sender in this communication network.

The communication network can be a fixed telecommunications network (TDM network), a packet-switched network (IP network), in particular the Internet, or a further mobile radio network, which is unequal to the home network. In the case of the realization as fixed telecommunications network, a communication between the sender of the message and the mobile radio gateway takes place via a TDM data connection. When using a packet-switched network for the communication between the sender of the message and the mobile radio gateway, a VoIP connection is established in one aspect of the invention. The automatically effected VoIP registration provides an IP address of the sender of the message as assignment information. For the case that a further mobile radio network is used as communication network, the mobile radio terminal under consideration for example includes two SIM cards. While the SIM information data of the one SIM card are sent to the mobile radio gateway, the other SIM card of the mobile radio gateway is used to send this information via another mobile radio network. The message for example is sent as SMS from the mobile radio terminal to the mobile radio gateway.

In one exemplary aspect of the invention, the automatic generation of a message is effected by a software application which is implemented on the mobile radio terminal. The message is generated automatically in the sense that the software application automatically compiles the information contained in the message and embeds the same in a message. It can, however, be provided that the application asks the user of the mobile radio terminal whether he wishes the automatic generation of a corresponding message, and the user must confirm this. The message is sent to the mobile radio gateway via a network to which the mobile radio terminal has direct access (and which of course is unequal to the home network of the mobile radio terminal). This network for example is a WLAN or another mobile radio network.

If the message with the SIM information data is sent by a device assigned to the mobile radio terminal, it is provided in one aspect that the SIM information data are transmitted from the mobile radio terminal via the function “SIM-Access-Profiles” to the device connected with the mobile radio terminal, which thereupon generates and sends the message or, if the message already has been generated in the mobile radio terminal, merely sends the message. The function “SIM-Access-Profiles” is standardized in the Bluetooth data transmission standard; conventionally it is used for mobile radio communication in motor vehicles. The assigned device communicates with the mobile radio gateway for example via VoIP.

In one exemplary aspect of the invention it is provided that the message automatically generated in the mobile radio terminal already contains assignment information for identifying the sender of the message at the mobile radio gateway. For this purpose it can be provided, for example, that sender information of the sender is integrated into the message.

It can, however, likewise be provided that such assignment information is sent to the mobile radio gateway in connection with separate messages or provided at the mobile radio gateway and the mobile radio terminal by a previously effected configuration. In connection with such configuration it can be provided, for example, that mobile radio terminals and devices assigned to the same contain a privately agreed code or a particular identification number. When the mobile radio gateway receives such code or such identification number, it automatically assigns a particular sender information and a predefined communication network to the sender on the basis of such code or such identification number.

The assignment information which provides for a communication between the mobile radio gateway and the sender of the message can newly be generated and provided for each TC connection. Alternatively, it can be provided that such assignment information is fixed for an extended period and for a plurality of TC connections.

The message generated in the mobile radio terminal or the device assigned to the mobile radio terminal can be sent to the mobile radio gateway directly or alternatively via a SIM server. It can be provided that all functions of the mobile radio gateway or at least the functions relevant for the present method are controlled via a SIM server. When routing the message via a SIM server, no particularities otherwise are obtained: since a SIM server anyway transmits a SIM card to a mobile radio gateway virtually, i.e. by means of the corresponding SIM information data, the SIM information data contained in the generated message are not different from other SIM information data which the SIM server transmits to the mobile radio gateway.

The method according to the invention in particular regards telephone calls, SMS messages and data connections such as point-to-point connections as TC connections. Just like incoming telephone calls, incoming SMS messages or data connections also can be forwarded at low cost according to the method of the invention. The SMS messages and useful data of the data connections likewise are transmitted via the further communication network, possibly by using suitable standards, between the mobile radio terminal and the mobile radio gateway.

The invention furthermore relates to a mobile radio gateway which has the following features:
a plurality of radio modules for the mobile radio communication, wherein a plurality of SIM cards are assigned and/or assignable to the mobile radio gateway, which each provide for a utilization of a radio module for the mobile radio communication,
means which are suitable to detect a message sent directly or indirectly from a mobile radio terminal or a device connected with the mobile radio terminal to the mobile radio gateway, which includes the SIM information data of a SIM card of the mobile radio terminal or which identifies the SIM card, wherein a first call number is assigned to the SIM card,
a module which after receipt of the message at the location of the mobile radio gateway inscribes in the home network of the mobile radio terminal by using the SIM information data received or by using a partner SIM card, so that each TC connection addressed to the first call number is routed to the mobile radio gateway,
means which detect and/or generate assignment information for identifying the sender of the message, and
means which forward a TC connection addressed to the first call number of the mobile radio terminal and routed to the mobile radio gateway to the sender of the message by using the assignment information.

The means which realize said functionalities of the mobile radio gateway for example are provided by software.

### BRIEF DESCRIPTION OF THE DRAWINGS

The invention will be explained in detail below by means of several exemplary embodiments with reference to the Figures of the drawing.

FIG. 1 shows a first exemplary embodiment of a telecommunications arrangement which is suitable and formed for carrying out the method according to the invention.

FIG. 2 shows a second exemplary embodiment of a telecommunications arrangement which is suitable and formed for carrying out the method according to the invention.

FIG. 3 shows a third exemplary embodiment of a telecommunications arrangement which is suitable and formed for carrying out the method according to the invention.

FIG. 4 shows a flow diagram which indicates steps of an exemplary method according to the invention for routing TC connections to a mobile radio gateway.

### DETAILED DESCRIPTION

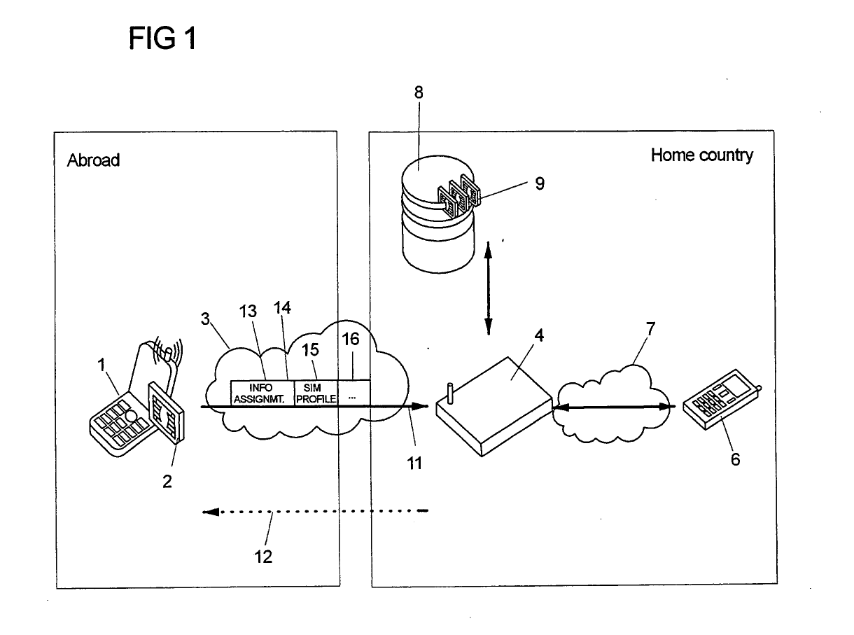

FIG. 1 shows a telecommunications arrangement which comprises networks and telecommunications components with which a method according to the invention for routing TC connections to a mobile radio terminal can be realized.

As essential components, the telecommunications arrangement comprises a mobile radio terminal 1 and a mobile radio gateway 4. Optionally, a SIM server 8 is provided in addition. The mobile radio gateway 4 is connected to a home network 7 of the mobile radio terminal 1. To the home network 7 further mobile radio terminals 6 are connected.

According to FIG. 1, the situation is considered in which the mobile radio terminal 1 and its user are located abroad. The term “abroad” serves for delimitation against the country or region in which the home network of the mobile radio terminal 1 is located (“home country”). In further exemplary embodiments, for which the following observations apply correspondingly, the mobile radio terminal 1 and its user on the other hand are not located abroad, but in the country or the region in which also the home network is realized. It can also be provided that the mobile radio terminal 1 is located at a place in the home country or abroad, at which there is no access to any mobile radio network.

To the mobile radio terminal 1 a SIM card 2 is assigned, which unambiguously identifies a network subscriber and which assigns the mobile radio terminal 1 to the home network 7. In a manner known per se, the SIM card 2 includes an IMSI number and further information.

In addition to its access to its home network 7 to be realized via the SIM card 2, the mobile radio terminal 1 possesses access means for an access to a further communication network 3. In the illustrated exemplary embodiment, the mobile radio terminal 1 therefore is formed as telephone which supports the industrial standard “Wifi” or another WLAN standard. Thus, it is a WLAN-enabled mobile radio terminal 1. Via its WLAN functionality, the mobile radio terminal 1 has an access to a WLAN 3 as further communication network, wherein the WLAN is coupled with the Internet via a non-illustrated gateway or the like.

The mobile radio gateway 4 includes a plurality of radio modules for the mobile radio communication. To the mobile radio gateway 4 a plurality of SIM cards are assigned or assignable, which each provide for a utilization of a radio module for the mobile radio communication. At least some of the assigned or assignable SIM cards of the mobile radio gateway 4 are assigned to the home network 7, so that a radio module of the mobile radio gateway 4 itself represents a mobile radio terminal during a mobile radio communication with a further mobile radio terminal 6 via the home network 7.

It can be provided that the home network 7 can be interconnected with further mobile radio networks and/or one or more fixed telecommunications networks and/or IP networks and the further mobile radio terminal 6 is connected with the home network 7 not directly, but via one or more further networks.

The optionally provided SIM server 8 includes a pool of SIM cards 9. Depending on the demand, a SIM card 9 is provided to the mobile radio gateway 4 by the SIM server 8, wherein providing such SIM card 9 is not effected physically, but merely the SIM information data, which identify a SIM card and reflect its functionality, are transmitted to the mobile radio gateway 4 by data transmission.

In the following, the case is considered where the SIM card 2 assigned to the home network 7 is not to be used for the mobile radio communication when the mobile radio terminal 1 is located abroad. The reason for example consists in that the utilization of the available mobile radio network would be connected with too high roaming fees and/or a mobile radio network currently is not available. This is automatically recognized in the mobile radio terminal 1, for example due to an operation abroad or by recognizing an existing alternative mobile radio network. Alternatively or in addition, it can be provided that the user of the mobile radio terminal can manually indicate that the current SIM card is not to be used for the communication.

In this case, a software application present in the mobile radio terminal 1 generates a message which at least comprises the SIM information data of the SIM card 2. This message is transmitted to the mobile radio terminal 1 via a data connection 11, which is realized via the WLAN 3 and the Internet to the mobile radio terminal 1. For this purpose it is provided that the mobile radio terminal 1 performs a VoIP registration, in which a sender address (in general a dynamically assigned IP address) is assigned to the same. The mobile radio terminal 1 now generates a message 13, which as information fields comprises the SIM information data 15 and information data 14 concerning an assignment and identification of the mobile radio terminal 1, wherein these information data 14 can be provided by the assigned sender address. The message can contain further information 16.

In FIG. 1, the message 13 only is shown schematically. The concrete set-up of the message 13 can be effected in some other way. The information 13 is sent to the mobile radio gateway 4 via the WLAN 3 and the VoIP connection established to the mobile radio gateway 4. This sending can be effected directly or alternatively via the SIM server 8. In the latter case, the SIM server 8 would forward the message 13 to the mobile radio gateway 4.

With reference to the assignment information 14, the gateway 4 is able to send data to the mobile radio terminal 1 via a data connection 12, likewise via the Internet and the WLAN 3. A logical connection between the mobile radio terminal 1 and the mobile radio gateway 4 exists via the communication network 3.

After receipt of the message 13, a radio module of the mobile radio gateway 4 inscribes at the location of the mobile radio gateway 4 in the home network 7 by using the SIM information data received. The SIM card 2 thus is virtually provided at the mobile radio gateway 4 and inscribed there into the mobile radio network 7. This leads to the fact that every connection addressed to the call number of the SIM card 2 is routed to the mobile radio gateway 4. The same then forwards such TC connection via the data connection 12 to the sender of the message received, i.e. the mobile radio terminal 1, by using the assignment information 14.

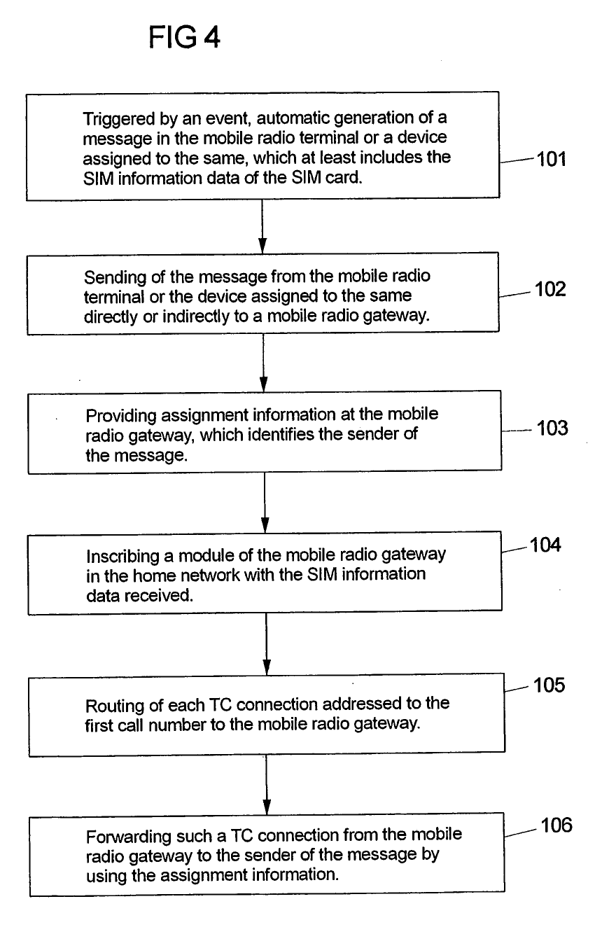

The corresponding method steps are again shown in FIG. 4 in a chronological order. In a first step 101—triggered by an event such as for example the automatic recognition of a foreign mobile radio network—a message 13 is generated in the mobile radio terminal 1, which at least contains the SIM information data 15 of the SIM card, which also can be referred to as SIM profile. In step 102, such message 13 thereupon is directly or indirectly sent from the mobile radio terminal 1 via the SIM server 8 to the mobile radio gateway 4. To ensure that the sender of the message 13, i.e. in the case under consideration the mobile radio terminal 1, can be assigned as sender to the mobile radio gateway 4, assignment information is provided at the mobile radio gateway 4, step 103. Said assignment information can be provided automatically, e.g. in connection with a VoIP registration of the mobile radio terminal 1, or by a suitable configuration. Such configuration for example provides that a certain code is assigned to the mobile radio terminal, upon receipt of which the mobile radio gateway 4 knows via which network and with which address it can communicate with the mobile radio terminal 1. For such a case, such code would be contained in the information field 14 of the message 13.

In step 104, one of the radio modules of the mobile radio gateway 4 now is inscribed in the home network 7 by using the SIM information data received. In the following, no further distinction is made between the corresponding radio module of the mobile radio gateway 4 and the mobile radio gateway 4. In step 105, each TC connection addressed to the first call number of the SIM card 2 is routed to the mobile radio gateway 4 due to the inscription of the SIM card at the mobile radio gateway 4. The same then forwards such TC connection to the sender of the message 13, i.e. to the mobile radio terminal 1, by using the contained assignment information. All incoming calls thus are routed to the mobile radio terminal 1 via the mobile radio gateway and the communication network 3. Correspondingly, calls going out from the mobile radio terminal also are routed to a communication partner 6 via the mobile radio gateway 4.

The method according to the invention is based on the idea to inscribe the SIM card at the mobile radio gateway 4 and not at the current location of the mobile radio terminal 1 and to then route the TC connections routed to the mobile radio gateway 4 via an inexpensive network such as a VoIP network to the mobile radio terminal 1.

It should be noted that by the term “routing” and “forwarding” a TC connection it is meant that both the signaling information associated to a TC connection and the actual useful data (call data, SMS messages and other data such as data of a computer) are routed via the respectively concerned communication means and networks. Routing and forwarding a TC connection thus not only relates to the routing and forwarding of signaling information, but also of the actual useful data/call data. The call itself is routed to the mobile radio terminal 1 via the gateway 4 and the interconnected communication network 3.

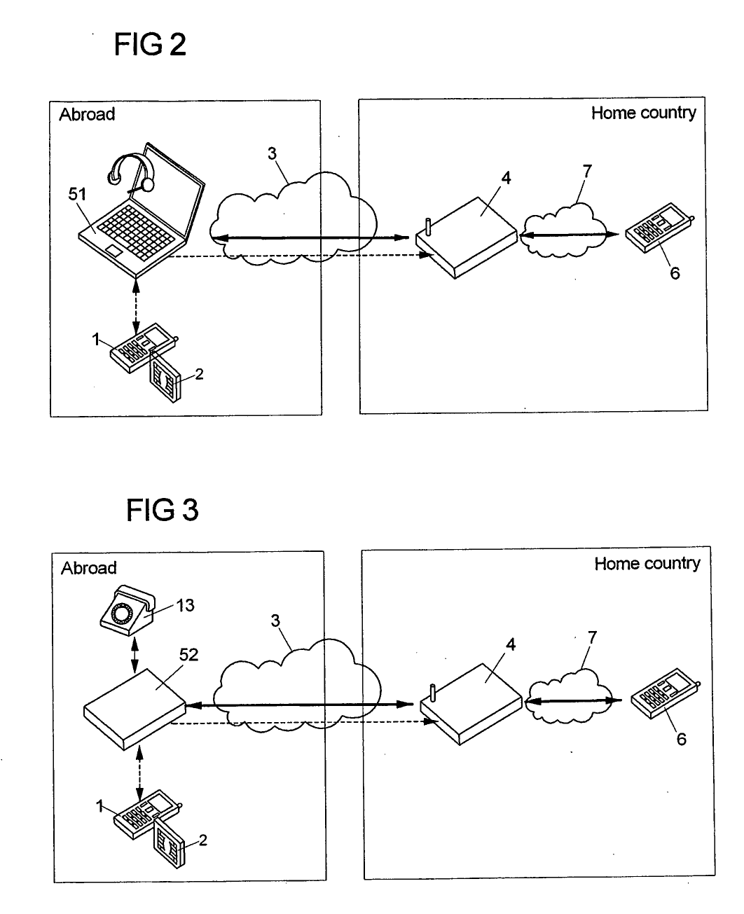

FIG. 2 shows a modification of the method explained with respect to FIGS. 1 and 4. In the exemplary embodiment of FIG. 2, a further device 51 is assigned to a mobile radio terminal 1, which in turn includes a SIM card 2. In the illustrated exemplary embodiment, the further device 51 is a notebook or a netbook. The method in principle proceeds as described with respect to FIG. 1, wherein however the message 13 of FIG. 1 is sent by the device 51 via the communication network 3 and a data transmission is effected between the device 51 and the mobile radio gateway 4.

To enable the device 51 to generate a message 13 with SIM information data 15 and send it to the mobile radio gateway 4, the mobile radio terminal 1 must send the corresponding SIM information data to the device 51. This is effected for example by means of the radio transmission standard Bluetooth by using the Bluetooth data transmission protocol “SIM-Access-Profiles”. With this protocol it is possible to transmit SIM information data from the mobile radio terminal 1 to the device 51. Via this protocol, call data at the same time can be transmitted between the mobile radio terminal 1 and the device 51. Instead of Bluetooth, another radio transmission standard also can be be used for data transmission between the mobile radio terminal 1 and the device 51. A data transmission also can be effected e.g. via cable.

The notebook or netbook 51 can directly be connected with the Internet as communication network 3, for example via a DSL connection or via WLAN or another radio network.

In this design variant it thus is provided that the SIM information data are passed on to the notebook or netbook 51 via Bluetooth. The notebook 51 realizes a VoIP connection with the mobile radio gateway 4 via an integrated SoftPhone. Via this SoftPhone of the notebook 51 a data transmission is realized between the device 51 and the mobile radio gateway 4. At the location of the mobile radio gateway 4, as described above in FIG. 1, the SIM card 2 or its SIM information data are inscribed in the home network 7. Incoming calls thus are first routed to the mobile radio gateway 4 and from the same to the notebook or netbook 51, which communicates the received or sent call data via Bluetooth with the mobile radio terminal 1.

FIG. 3 shows a further design variant of the method represented in FIG. 1. In this design variant, the mobile radio terminal 1, which in turn includes a SIM card 2, is connected with the mobile radio network 3 via an integrated access device (IAD). An integrated access device is a device for the network termination of NGN connections (NGN—Next Generation Network). To the integrated access device further terminals can be connected, such as an analog or ISDN telephone 13. The integrated access device 52 performs the function of a media gateway and establishes communication connections via the mobile radio network 3 to the mobile radio gateway 4. The SIM information data in turn are transmitted from the mobile radio terminal 1 to the integrated access device 52 for example via Bluetooth or another radio standard. The method then is effected as described above.

The communication network 3 can be a VoIP network such as the Internet. The access to the Internet for example can be effected via a DSL connection or via a WLAN. The communication network 3 can however also be another inexpensive network, for example a TDM network, i.e. an international fixed network. A call data transmission via a TDM network is inexpensive as compared to costs incurred with an international roaming.

In the exemplary embodiments of FIGS. 2 and 3, the mobile radio terminal 1 also can be connected with the device 51, 52 in some other way, for example via a cable.

The invention is not limited in its design to the exemplary embodiments explained above, which should merely be understood by way of example. For example, for communication between the mobile radio terminal 1 and the mobile radio gateway 4 networks and/or communication standards other than the ones shown can be used. It can also be provided that the message 13 contains further information, for example authentication information concerning the respective connection set up between the sender of the message and the mobile radio gateway. A further modification provides that not the SIM information data, but information which identifies the SIM card, is sent in the message and used to inscribe a partner SIM card of the SIM card in the mobile radio gateway.

1. A method for routing telecommunications connections (TC connections) to a mobile radio terminal which is not located in the receive region of its home network, wherein the mobile radio terminal includes a SIM card with SIM information data assigned to the home network and a first call number is assigned to the SIM card, and wherein the method comprises the following steps:
triggered by an event, automatic generation of a message in the mobile radio terminal or a device assigned to the same, which includes at least the SIM information data of the SIM card or an information which identifies the SIM card;
sending of the message from the mobile radio terminal or the device connected with the mobile radio terminal directly or indirectly to a mobile radio gateway;
providing assignment information at the mobile radio gateway, which identifies the sender of the message;
after receipt of the message at the mobile radio gateway inscribing a module of the mobile radio gateway at the location of the mobile radio gateway in the home network by using the received SIM information data or by using a partner SIM card, so that each TC connection addressed to the first call number is routed to the mobile radio gateway; and
forwarding such TC connection from the mobile radio gateway to the sender by using the assignment information.

2. The method according to claim 1, wherein furthermore each TC connection which goes out from the mobile radio terminal first is routed to the mobile radio gateway and is sent from the same via the home network.

3. The method according to claim 1, wherein the sending of the message from the mobile radio terminal or a device connected with the mobile radio terminal to the mobile radio gateway as well as forwarding of a TC connection between the mobile radio terminal and the mobile radio gateway is effected via at least one communication network.

4. The method according to claim 3, wherein the assignment information contains an address of the sender in the communication network.

5. The method according to claim 3, wherein the at least one communication network is a fixed telecommunications network, a packet-switched network, in particular the Internet, or a further mobile radio network which is unequal to the home network.

6. The method according to claim 1, the event which generates the message is
a detection in the mobile radio terminal or the device connected with the mobile radio terminal that
a foreign mobile radio network is present at the current location of the mobile radio terminal, and/or
a mobile radio network alternative to the home network is present at the current location of the mobile radio terminal, and/or
no or no desired mobile radio network is present at the current location of the mobile radio terminal, or
a defined manual input of a user of the mobile radio terminal.

7. The method according to claim 1, wherein the message is generated by a software application of the mobile radio terminal.

8. The method according to claim 1, the device connected with the mobile radio terminal, which generates the message, is a PC, a notebook, a netbook or an integrated access device.

9. The method according to claim 1, wherein the SIM information data are transmitted from the mobile radio terminal via the function SIM-Access-Profiles and a radio data transmission to the device connected with the mobile radio terminal, which device thereupon sends the message.

10. The method according to claim 1, wherein the message automatically generated in the mobile radio terminal already contains the assignment information for identifying the sender of the message at the mobile radio gateway.

11. The method according to claim 1, wherein the assignment information is provided automatically at the mobile radio gateway by such as a VoIP registration.

12. The method according to claim 1, wherein the assignment information is provided by means of a corresponding configuration of the mobile radio terminal and the mobile radio gateway.

13. The method according to claim 1, wherein the assignment information is newly generated and provided for each TC connection.

14. The method according to claim 1, wherein the generated message is sent directly to the mobile radio gateway.

15. The method according to claim 1, wherein the generated message is sent to the mobile radio gateway via a SIM server.

16. The method according to claim 1, wherein the TC connections under consideration are telephone calls, SMS messages and/or data connections.

17. The method according to claim 1, wherein the information which identifies the SIM card is used to inscribe a partner SIM card of the SIM card in the mobile radio gateway.

18. The method according to claim 1, wherein the partner SIM card is arranged in a SIM server and the data of the partner SIM card relevant for an authentication are transmitted to the mobile radio gateway, when the generated message arrives at the mobile radio gateway and/or the SIM server.

19. A mobile radio gateway, which comprises:
a plurality of radio modules for the mobile radio communication, wherein a plurality of SIM cards are assigned and/or assignable to the mobile radio gateway, which each provide for a utilization of a radio module for the mobile radio communication,
a module configured to detect a message sent directly or indirectly from a mobile radio terminal or a device connected with the mobile radio terminal to the mobile radio gateway, which includes the SIM information data of a SIM card of the mobile radio terminal or which identifies the SIM card, wherein a first call number is assigned to the SIM card,
a module which after receipt of the message at the location of the mobile radio gateway inscribes in the home network of the mobile radio terminal by using the SIM information data received or by using a partner SIM card, so that each TC connection addressed to the first call number is routed to the mobile radio gateway,
a module configured to detect and/or generate assignment information for identifying the sender of the message, and
a module configured to forward a TC connection addressed to the first call number of the mobile radio terminal and routed to the mobile radio gateway to the sender of the message by using the assignment information.

20. The mobile radio gateway according to claim 19, wherein the mobile radio gateway is formed to furthermore receive every TC connection which goes out from the mobile radio terminal via a communication network and send it to the receiver of the TC connection via the home network.

21. The mobile radio gateway according to claim 19, wherein the mobile radio gateway is formed to receive the message via a communication network and forward a TC connection to the mobile radio terminal via the communication network.

22. The mobile radio gateway according to claim 19, wherein the mobile radio gateway is formed such that at least some of the functions of the mobile radio gateway are controlled via a SIM server, in particular the mobile radio gateway receives the data of a partner SIM card relevant for an authentication from a SIM server, wherein the partner SIM card is arranged in the SIM server.
